(19) United States
(12) Patent Application Publication
(10) Pub. No.: US 2006/0069813 A1
(43) Pub. Date: Mar. 30, 2006

(54) Self-configuring peripheral interface system, peripheral device therefor and interface method

(75) Inventors: Jeffrey R. Biamonte, Hyde Park, NY (US); Timothy M. Trifilo, Poughkeepsie, NY (US)

Correspondence Address: HESLIN ROTHENBERG FARLEY & MESITI P.C., 5 COLUMBIA CIRCLE, ALBANY, NY, 12203, US

(73) Assignee: International Business Machines Corporation, Armonk, NY (US)

(21) Appl. No.: 10/954,780

(22) Filed: Sep. 30, 2004

(51) Int. Cl. G06F 3/00

(52) U.S. Cl. 710/8

(57) ABSTRACT

A self-configuring peripheral interface system and method are provided wherein at least one peripheral device may be coupled to a master device across a physical interface. The at least one peripheral device includes relocatable device driver code embodied as read only memory code and an associated peripheral functional component. The relocatable device driver code allows the master device to communicate with the associated peripheral functional component when copied from the peripheral device to an available device driver memory space accessible by the master device. The master device activates logic to automatically initiate copying of the relocatable device driver code from the at least one peripheral device when the at least one peripheral device is coupled to the master device via the physical interface.

### TECHNICAL FIELD

This invention relates in general to device interface techniques, and more particularly, to a self-configuring peripheral interface system, peripheral device therefor and interface method for facilitating communications between a master device and one or more peripheral devices coupled thereto across a physical interface.

### BACKGROUND OF THE INVENTION

A dedicated, high pin count bus interface is often required to connect a master device, such as an embedded system, to one or more upgrade or add on peripheral devices. For example, a video game system cartridge, which typically has many interface pins to accommodate address and data signals, as well as decode lines, conventionally must also include separate lines for interfacing each add on peripheral device to the master system. Using the example of a portable video game console, it may be desirable to have a digital camera peripheral device, audio input peripheral device, printer peripheral device, or even additional game controllers for multiple players connected to the video game controller. In order for existing systems to implement this functionality, they require one of the following:
A read only memory (ROM) cartridge within the embedded system that must be used in order to enable the basic add on function. This works well, but requires a high pin count ROM cartridge at the master device for each peripheral device.
Microcode to operate all peripheral devices anticipated at the time the existing system is offered. The problem with this approach is that it is static and it is difficult to predict what peripheral devices might be sold in the future. In addition, memory may be wasted using this approach. The USB protocol employs this technique and makes provision for new peripheral devices to be added later. In a computer system such as a personal computer, this is allowable in part because there is an abundance of code storage space.

A need thus remains in the art for an enhanced, self-configuring peripheral interface technique, particularly for coupling one or more peripheral devices to a master device such as an embedded system, which minimizes the physical interface pin count requirements and does not require prestored microcode to operate all possible peripheral devices at the time the master device is offered for sale.

### SUMMARY OF THE INVENTION

The shortcomings of the prior art are overcome and additional advantages are provided through a peripheral interface system which includes a master device coupled to a physical interface for connecting at least one peripheral device thereto, and logic activated by the master device to automatically initiate copying of relocatable device driver code from the at least one peripheral device when the at least one peripheral device is coupled to the master device via the physical interface. The copied device driver code facilitates communication by the master device with the at least one peripheral device.

In another aspect, a peripheral device is provided that is connectable to a master device via a physical interface. This peripheral device includes a peripheral functional component and relocatable device driver code. The relocatable device driver code is stored in non-volatile memory of the peripheral device, and is copied by a master device when the peripheral device is coupled thereto across a physical interface. The relocatable device driver code facilitates communication by the master device with the peripheral functional component of the peripheral device.

In yet another aspect, a peripheral interface system is provided that includes a master device coupled to a physical interface and at least one peripheral device coupled to the master device across the physical interface. The at least one peripheral device includes at least one peripheral functional component and at least one relocatable device driver code stored in at least one non-volatile memory of the at least one peripheral device. The peripheral interface system further includes logic activated by the master device to automatically initiate copying by the master device of the at least one relocatable device driver code from the at least one peripheral device. The at least one relocatable device driver code facilitates communication by the master device with the at least one peripheral functional component.

In a further aspect, a method of interfacing a peripheral device and a master device is provided. The method includes: providing the master device with a physical interface for connecting at least one peripheral device thereto, and logic for automatically initiating copying of relocatable device driver code from the at least one peripheral device when the at least one peripheral device is coupled thereto via the physical interface; and providing relocatable device driver code stored within non-volatile memory of each of the at least one peripheral device for accessing an associated peripheral functional component thereof, the relocatable device driver code facilitating communication by the master device with the associated peripheral functional component of the at least one peripheral device when copied by the master device from the non-volatile memory of the peripheral device.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an exemplary, conventional serial clock and serial data interface showing a fixed number of peripheral devices connected to a master device;

FIG. 2 depicts one embodiment of a self-configuring peripheral interface system, in accordance with an aspect of the present invention;

FIG. 3 is a flowchart embodiment of logic initiated by a master device for reading relocatable device driver code from one or more peripheral devices coupled thereto, in accordance with an aspect of the present invention; and

FIG. 4 depicts another embodiment of a peripheral interface system wherein a pass through connector is associated with each peripheral device for coupling the multiple peripheral devices to the master device through a single shared interface, in accordance with an aspect of the present invention.

### BEST MODE FOR CARRYING OUT THE INVENTION

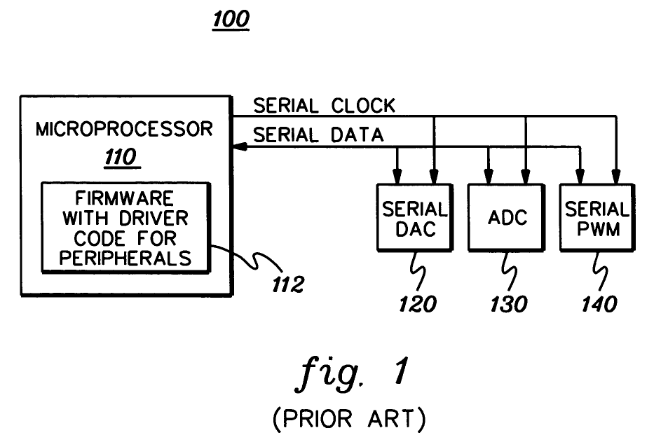

FIG. 1 depicts one embodiment of a conventional peripheral device interface system, generally denoted 100, wherein a microprocessor 110 has multiple fixed function peripheral devices 120, 130 & 140 serially connected thereto via a serial clock bus and a serial data bus. The serial interface between microprocessor 110 and peripheral devices 120, 130 & 140 can comprise any one of numerous serial interfaces or buses available in the art, such as the 12C and 12S interfaces offered by Philips Semiconductor, and the Motorola SPI bus. In this embodiment, the interface between the microprocessor 110 and the multiple peripheral devices 120, 130, 140 is non-customer upgradeable; that is, this system has a fixed number of functional peripheral devices coupled thereto which may not be modified by the customer. In this example, these devices are a serial digital-to-analog converter (DAC) 120, an analog-to-digital converter (ADC) 130 and a serial pulse width modulator (PMW) 140. Microprocessor 110 communicates with each peripheral device using resident firmware 112 having device driver code for each of the peripheral devices. As noted, this fixed function configuration does not allow for the coupling of additional peripheral devices to the master device (i.e., microprocessor 110 in this example) other than those contemplated at the time the system is produced, thus limiting flexibility of the overall system.

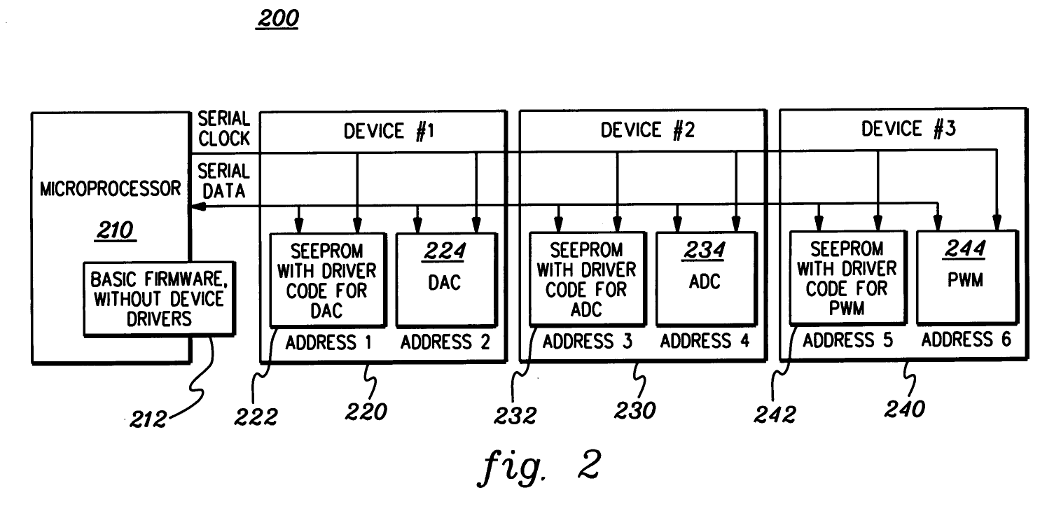

FIG. 2 depicts one example of a self-configuring, upgradable peripheral interface system, generally noted 200, in accordance with an aspect of the present invention. In this system, a master device, such as microprocessor 210 (which may, for example, be an embedded system processor) includes a physical interface to one or more peripheral devices, labeled device #1 220, device #2 230 and device #3 240, with three peripheral devices being shown by way of example only. Devices 220, 230 & 240 are in this example serially connected through a physical interface (comprising a serial clock bus and a serial data bus) to microprocessor 210.

Each peripheral device includes relocatable device driver code stored within non-volatile memory at one address and an associated peripheral functional component at a second address thereof. This sequential addressing of non-volatile storage memory and the peripheral functional component is significant, and in accordance with one aspect of the present invention, is repeated for each of the peripheral devices to be coupled to the master device across the single shared interface. Thus, each peripheral device essentially compromises a single unit with two components, i.e., a non-volatile storage component and the actual peripheral functional component. Both of these components are separately addressed. For example, peripheral device 220 includes a digital-to-analog converter (DAC) component 224 at address 2 and a serial EEPROM (SEEPROM) with relocatable device driver code at address 1 222 for accessing the DAC component at address 2. Peripheral device #2 230 has an analog-to-digital converter functional component 234 at address 4 with an associated SEEPROM containing relocatable device driver code for accessing the ADC functional component at address 3 232. Peripheral device #3 240 includes a PWM functional component 244 at address 6 and an associated SEEPROM with device driver code for accessing the PWM functional component at address 5 242.

Note that the addressing order of the storage ROM and the associated peripheral functional component within each peripheral device is shown by way of example only. In an alternative example, the functional component of each peripheral device could be located at a first address and the relocatable device driver code in non-volatile memory at a second address thereof. The addressing organization of the peripheral functional component and relocatable device driver code within each peripheral device should be uniform, however, as explained further below. Note further that the three peripheral devices 220, 230 & 240 are shown by way of example only. The concepts disclosed herein are applicable to any number of peripheral devices of a type such as those depicted, as well as other peripheral devices such as a camera, a printer, a video capture device, a programmable gain amplifier, a game device, a video display, any human input device, any embedded application, etc. Advantageously, the peripheral interface system disclosed herein is modular in design and readily upgradeable by a customer simply by coupling additional peripheral devices (with the format described herein) to the master device via, for example, a single shared physical interface.

Microprocessor 210 includes a common, generic code which facilitates copying of relocatable device driver code into memory accessible by the master device from each of the peripheral devices coupled thereto. This common, generic code is referred to in FIG. 2 as the basic firmware, without device drivers 212. In one embodiment, the master device is assumed to not have access internally to device drivers for one or more of the peripheral devices coupled thereto, but rather, relies upon a copying of relocatable device driver code from the respective peripheral devices when the devices are connected to the master device. In this way, the peripheral interface system is modular and self-configuring in design. Further, the peripheral interface system is assumed accessible to a user via a simple pass through connector (of 3, 4 or 6 pins in a serial interface by way of example). Thus a single shared interface can be used to couple an essentially unlimited number of peripheral devices to a master device. This modular design allows the master device to communicate with a plurality of peripheral devices coupled thereto in any order, any one or more of which may have been non-existent at the time that the master device was manufactured and offered for sale, and without any requirement that the master device be preprogrammed with custom logic for accessing a particular peripheral device. Thus, the present invention presents a dynamic, modular design that offers great flexibility to a customer to add on peripheral devices as desired.

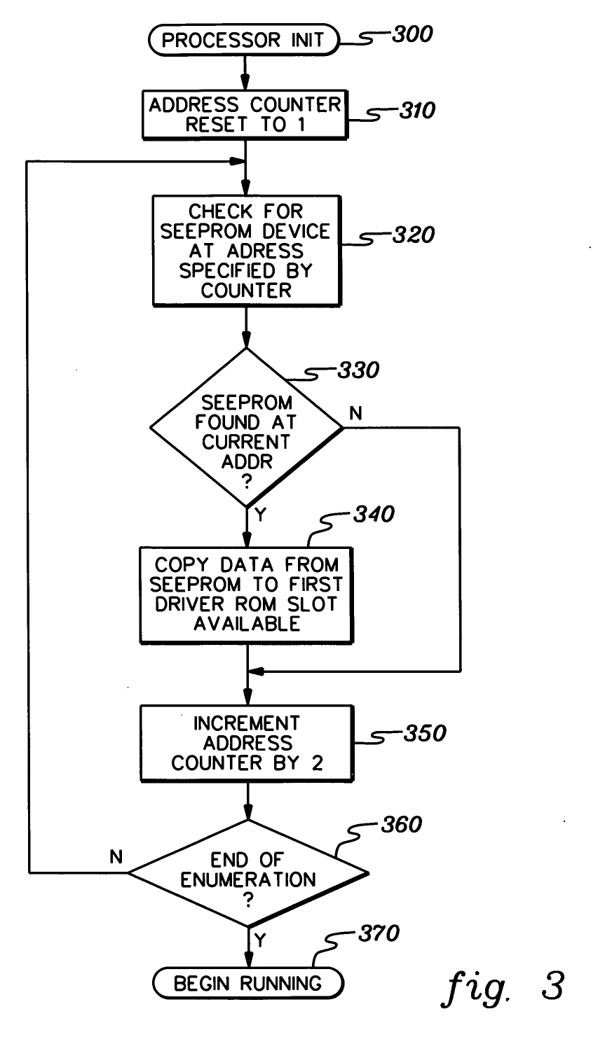

FIG. 3 depicts one embodiment of the common, generic code logic accessed by the master device (which in one example comprises a microprocessor). Upon processor initialization 300 the logic looks at the serial bus interface to determine whether there are any peripheral devices coupled thereto. Again, a serial bus interface is assumed by way of example only. The concepts described herein are readily applicable to a parallel bus interface as well.

An address counter is reset to “1” 310, and the logic checks for a SEEPROM device (i.e., one example of non-volatile memory) having relocatable device driver code at the address specified by the counter 320 (i.e., the processor performs a read of address #1). The processor determines whether a SEEPROM is found at the current address 330, and if so copies the relocatable device driver code from the SEEPROM to a first driver ROM memory slot available at the master device 340. Note again that peripheral devices can be coupled in any order, and thus discovered in any order. Addresses are essentially assigned electromechanically as the peripheral devices are coupled together to the serial peripheral interface. Thereafter, or if a SEEPROM was not found at the current address, (e.g., the inquiry times out) the counter is incremented by 2 350, and the logic determines whether it has reached the end of a specified enumeration 360 (e.g., until an arbitrary number of addresses are tested). If no, then the process repeats until the end of the enumeration is reached, after which the master device begins running the identified peripheral(s) using the copied relocatable device driver code(s).

Relocatable psuedocode is well known to one skilled in the art. For example, a simple relocatable code example is:
Function:
   Variable A=3
Loop:
   Add 4 to variable A
   If A is not even, go back one step.

Since the branch back to Loop is relative to the current position (back one step) this code is relocatable. Thus, device driver code for the functional component of a peripheral device can be readily written to be relocatable by one skilled in the art, and then stored in non-volatile memory. This relocatable device driver code can use absolute addressing only for the registered address of the associated peripheral functional component of the peripheral device.

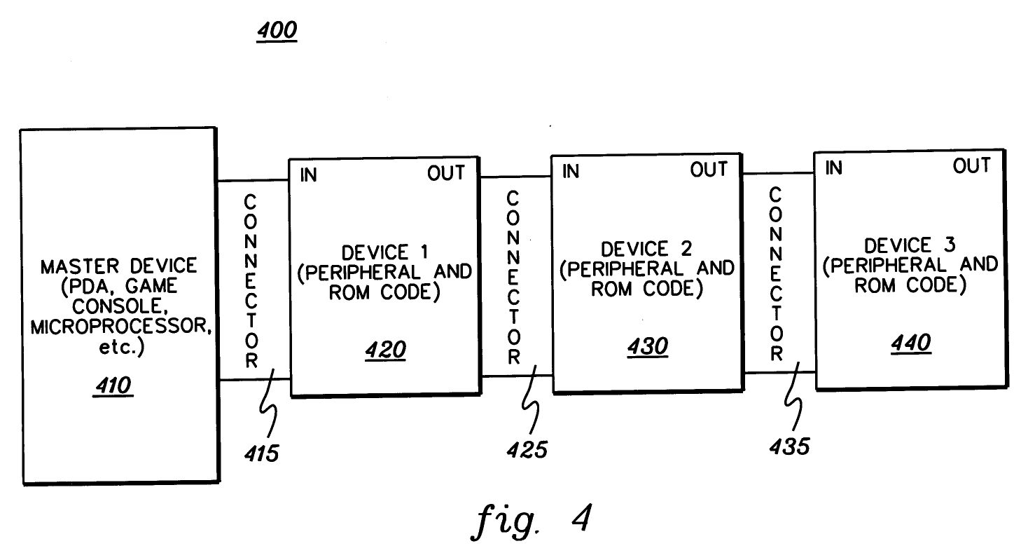

FIG. 4 depicts another embodiment of a peripheral interface system 400, in accordance with an aspect of the present invention. In this system, three peripheral devices 420, 430 & 440 are again shown by way of example serially coupled to a master device 410 (such as a PDA, game console, microprocessor, etc.). The peripheral devices each share a single physical interface with the master device by employing pluggable, pass through connectors 415, 425 & 435. A first pluggable connector 415 connects peripheral device 420 to master device 410, while a second pluggable connector 425 couples second peripheral device 430 to first peripheral device 420, and hence to the shared physical interface of master device 410, and a third pluggable connector 435 couples third peripheral device 440 to second peripheral device 430, and hence to first peripheral device 420 and master device 410. Pluggable connectors suitable for this use are well known in the art, and could comprise an industry standard DIN connector or card edge connector. Those skilled in the art will note that the pluggable, pass through connectors referenced herein could be designed as either a cable pass through or to mechanically snap together externally or as embedded pass through connectors of the respective peripheral devices as shown in FIG. 4. Further, the connectors could also facilitate powering of the peripheral devices from the master device, depending upon the peripheral functional components implemented thereby.

Those skilled in the art will note that presented herein is a modular peripheral interface system which allows a master device to self-configure for communication with one or more peripheral devices across, for example, a single shared physical interface, without requiring the master device to be preprogrammed with device drivers for each of the one or more peripheral devices. This is accomplished by providing each peripheral device with relocatable device driver code, meaning that the device driver code can be executed out of any location in RAM, including RAM available to the master device. The modular peripheral interface system presented does not depend upon the type of interface employed. For example, the interface may be a parallel interface or a serial interface. Further, various available physical interfaces may be utilized, including for example, a 12C serial bus, a 12S serial bus or a Motorola SPI bus. Advantageously, a simple four or six wire connector may be utilized to serially interface a master device to essentially unlimited peripheral functionality.

The capabilities of one or more aspects of the present invention can be implemented in software, firmware, hardware or some combination thereof.

One or more aspects of the present invention can be included in an article of manufacture (e.g., one or more computer program products) having, for instance, computer usable media. The media has therein, for instance, computer readable program code means or logic (e.g., instructions, code, commands, etc.) to provide and facilitate the capabilities of the present invention. The article of manufacture can be included as a part of a computer system or sold separately.

Additionally, at least one program storage device readable by a machine embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A peripheral interface system comprising:
a master device coupled to a physical interface for connecting at least one peripheral device thereto; and
logic activated by the master device to automatically initiate copying by the master device of relocatable device driver code from the at least one peripheral device when the at least one peripheral device is coupled to the master device via the physical interface, the copied device driver code facilitating communication by the master device with the at least one peripheral device.

2. The peripheral interface system of claim 1, wherein the logic comprises a common, generic code for facilitating copying of relocatable device driver code into memory accessible by the master device from a plurality of peripheral devices, when each of the plurality of peripheral devices is coupled to the master device via the physical interface, and wherein each copied device driver code facilitates communication by the master device with a corresponding functional component of the peripheral device from which the device driver code is copied.

3. The peripheral interface system of claim 1, wherein the master device lacks device driver capability for the at least one peripheral device prior to the copying of the relocatable device driver code by the master device from the peripheral device.

4. The peripheral interface system of claim 1, where the logic comprises logic to automatically check an address of the at least one peripheral device when the at least one peripheral device is coupled to the master device via the physical interface, and automatically initiate copying of relocatable device driver code when relocatable device driver code is found at the address of the at least one peripheral device.

5. The peripheral interface system of claim 4, wherein the logic to automatically initiate copying of relocatable device driver code comprises logic to automatically initiate copying of device driver code from non-volatile memory of the at least one peripheral device, when the at least one peripheral device is coupled to the master device via the physical interface, into an available device driver memory space accessible by the master device.

6. The peripheral interface system of claim 5, wherein the logic further comprises logic to perform the automatically initiating copying of relocatable device driver code from each peripheral device of a plurality of peripheral devices when the plurality of peripheral devices are coupled to the master device via the physical interface.

7. The peripheral interface system of claim 1, wherein the physical interface facilitates coupling of a plurality of peripheral devices to the master device, and wherein at least one peripheral device of the plurality of peripheral devices includes a pass through connector connectable to a pass through connector of another peripheral device of the plurality of peripheral devices for facilitating coupling of the at least one peripheral device to the master device via the pass through connector of the another peripheral device, and wherein the physical interface comprises a single shared interface.

8. The peripheral interface system of claim 7, wherein the single shared interface comprises a serial interface.

9. The peripheral interface system of claim 1, wherein the physical interface includes a clock bus and a data bus.

10. The peripheral interface system of claim 9, wherein the clock bus and data bus comprise a serial clock bus and a serial data bus, and wherein the at least one peripheral device is serially coupled to the master device via the physical interface.

11. A peripheral device connectable to a master device via a physical interface, the peripheral device comprising:
a peripheral functional component; and
relocatable device driver code stored in non-volatile memory of the peripheral device, the relocatable device driver code to be copied by a master device when the peripheral device is coupled thereto across a physical interface, and facilitating communication by the master device with the peripheral functional component.

12. The peripheral device of claim 11, wherein the peripheral device further comprises a pass through connector connectable to the physical interface for coupling of the peripheral device to the master device.

13. The peripheral device of claim 12, wherein the pass through connector is further connectable to another pass through connector of another peripheral device which is also connectable to the master device via the physical interface, wherein the peripheral device couples to the physical interface across the pass through connector of the another peripheral device.

14. The peripheral device of claim 11, wherein the non-volatile memory and the peripheral functional component are sequentially addressable within the peripheral device.

15. The peripheral device of claim 11, wherein the relocatable device driver code compromises read only memory code, and wherein the non-volatile memory compromises an EEPROM.

16. A peripheral interface system comprising:
a master device coupled to a physical interface;
at least one peripheral device coupled to the master device across the physical interface, the at least one peripheral device comprising
at least one peripheral functional component, and
at least one relocatable device driver code stored in at least one non-volatile memory of the at least one peripheral device; and
logic activated by the master device to automatically initiate copying by the master device of the at least one relocatable device driver code from the at least one peripheral device, wherein the at least one relocatable device driver code facilitates communication by the master device with the at least one peripheral functional component.

17. The peripheral interface system of claim 16, wherein the logic comprises a common, generic code for facilitating copying of relocatable device driver code into memory accessible by the master device from a plurality of peripheral devices, when each of the plurality of peripheral devices is coupled to the master device via the physical interface, and wherein each copied device driver code facilitates communication by the master device with a corresponding peripheral functional component of the peripheral device from which the relocatable device driver code is copied.

18. The peripheral interface system of claim 16, wherein the master device lacks device driver code capability for the at least one peripheral device prior to the copying of the relocatable device driver code by the master device from the peripheral device.

19. The peripheral interface system of claim 16, wherein the logic comprises logic to automatically check an address of the at least one peripheral device, and logic to initiate copying of relocatable device driver code when relocatable device driver code is found at the address of the at least one peripheral device.

20. The peripheral interface system of claim 16, wherein the physical interface facilitates coupling of a plurality of peripheral devices to the master device, and wherein at least one peripheral device of the plurality of peripheral devices includes a pass through connector connectable to a pass through connector of another peripheral device of the plurality of peripheral devices for facilitating coupling of the at least one peripheral device to the master device via the pass through connector of the another peripheral device, and wherein the physical interface comprises a single shared interface.

21. The peripheral interface system of claim 20, wherein the single shared interface comprises a serial interface.

22. A method for interfacing a peripheral device and a master device, the method comprising:
providing the master device with a physical interface for connecting at least one peripheral device thereto, and logic for automatically initiating copying of relocatable device driver code from the at least one peripheral device when coupled thereto via the physical interface; and
providing relocatable device driver code stored within non-volatile memory of the at least one peripheral device, the relocatable device driver code facilitating communication by the master device with an associated peripheral function component of the at least one peripheral device when copied therefrom.

23. The method of claim 22, wherein the logic comprises a common, generic code for facilitating copying of relocatable device driver code into memory accessible by the master device from a plurality of peripheral devices, when each of the plurality of peripheral devices is coupled to the master device via the physical interface, and wherein each copied device driver code facilitates communication by the master device with a corresponding peripheral functional component of the peripheral device from which the relocatable device driver code is copied.

24. The method of claim 22, wherein the master device lacks device driver capability for the at least one peripheral device prior to copying of the relocatable device driver code by the master device from the at least one peripheral device.

25. The method of claim 22, wherein the physical interface facilitates coupling of a plurality of peripheral devices to the master device, and wherein at least one peripheral device of the plurality of peripheral devices includes a pass through connector connectable to a pass through connector of another peripheral device of the plurality of peripheral devices for facilitating coupling of the at least one peripheral device to the master device via the pass through connector of the another peripheral device, and wherein the physical interface comprises a single shared interface.
